(19) United States
(12) Patent Application Publication
(10) Pub. No.: US 2016/0182300 A1
(43) Pub. Date: Jun. 23, 2016

(54) Selective Configuring of Throttling Engines for Flows of Packet Traffic

(71) Applicants: Sadasiva Reddy Mopuri, Fremont, CA (US); Gunter Van de Velde, Lint (BE)

(72) Inventors: Sadasiva Reddy Mopuri, Fremont, CA (US); Gunter Van de Velde, Lint (BE)

(73) Assignee: Cisco Technology, Inc., a corporation of California, San Jose, CA (US)

(21) Appl. No.: 14/572,821

(22) Filed: Dec. 17, 2014

(51) Int. Cl. H04L 12/24; H04L 12/755; H04W 28/10

(52) U.S. Cl. CPC H04L 41/0896; H04W 28/10; H04L 45/021

(57) ABSTRACT

In one embodiment, a packet switching device receives a particular directive to throttle a flow of packet traffic. In response, the packet switching device performs an analysis to determine one or more reduced number of flow throttling engines of a plurality of flow throttling engines in the packet switching device configured to be responsive to a received directive to throttle a corresponding flow of packet traffic. The one or more reduced number of flow throttling engines correspond to learned one or more incoming interfaces on which packets of the flow of packet traffic are correct in being received, and the one or more reduced number of flow throttling engines is less than all of the plurality of flow throttling engines. The packet switching device configures to throttle the flow of packet traffic in each of said one or more reduced number of flow throttling engines.

### TECHNICAL FIELD

The present disclosure relates generally to processing packets in a communications network including packet switching devices.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology.

### BRIEF DESCRIPTION OF THE DRAWINGS

The appended claims set forth the features of one or more embodiments with particularity. The embodiment(s), together with its advantages, may be understood from the following detailed description taken in conjunction with the accompanying drawings of which:

FIG. 1 illustrates a network operating according to one embodiment;

FIG. 2A illustrates a packet switching device according to one embodiment;

FIG. 2B illustrates an apparatus according to one embodiment;

FIG. 3 illustrate a process according to one embodiment;

FIG. 4 illustrates a process according to one embodiment; and

FIG. 5 illustrates a process according to one embodiment.

### DESCRIPTION OF EXAMPLE EMBODIMENTS

1. Overview

Disclosed are, inter alia, methods, apparatus, computer-storage media, mechanisms, and means associated with selective configuring of throttling engines for flows of packet traffic. In one embodiment, a packet switching device receives a particular directive to throttle a flow of packet traffic. In response, the packet switching device performs an analysis to determine one or more reduced number of flow throttling engines of a plurality of flow throttling engines in the packet switching device configured to be responsive to a received directive to throttle a corresponding flow of packet traffic. The one or more reduced number of flow throttling engines correspond to learned one or more incoming interfaces on which packets of the flow of packet traffic are correct in being received, and the one or more reduced number of flow throttling engines is less than all of the plurality of flow throttling engines. The packet switching device configures to throttle the flow of packet traffic in each of said one or more reduced number of flow throttling engines, while at least one of the plurality of flow throttling engines associated with an interface and identified by said analysis as not correct in having packets of the flow of packet traffic being received is not configured to throttle the flow of packet traffic.

In one embodiment, the particular directive identifies the flow by a tuple including a source address prefix, partial or fully-expanded, for packets of the flow of packet traffic;

and wherein said performing the analysis includes performing a unicast reverse path forwarding (uRPF) check on the source address prefix in identifying said one or more incoming interfaces. In one embodiment, the uRPF check is performed in strict mode.

In one embodiment, the particular directive is received via one or more Border Gateway Protocol (BGP) messages; and wherein the particular directive includes a BGP Flowspec rule identifying the source address prefix, partial or fully-expanded, for packets of the flow of packet traffic.

### 2. Description

Disclosed are, inter alia, methods, apparatus, computer-storage media, mechanisms, and means associated with selective configuring of throttling engines for flows of packet traffic. Embodiments described herein include various elements and limitations, with no one element or limitation contemplated as being a critical element or limitation. Each of the claims individually recites an aspect of the embodiment in its entirety. Moreover, some embodiments described may include, but are not limited to, inter alia, systems, networks, integrated circuit chips, embedded processors, ASICs, methods, and computer-readable media containing instructions. One or multiple systems, devices, components, etc., may comprise one or more embodiments, which may include some elements or limitations of a claim being performed by the same or different systems, devices, components, etc. A processor may be a general processor, task-specific processor, a core of one or more processors, or other co-located, resource-sharing implementation for performing the corresponding processing. The embodiments described hereinafter embody various aspects and configurations, with the figures illustrating exemplary and non-limiting configurations. Computer-readable media and means for performing methods and processing block operations (e.g., a processor and memory or other apparatus configured to perform such operations) are disclosed and are in keeping with the extensible scope of the embodiments. The term “apparatus” is used consistently herein with its common definition of an appliance or device.

The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation). Also, nothing described or referenced in this document is admitted as prior art to this application unless explicitly so stated.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the terms “first,” “second,” etc., are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Finally, the term “particular machine,” when recited in a method claim for performing steps, refers to a particular machine within the 35 USC §101 machine statutory class.

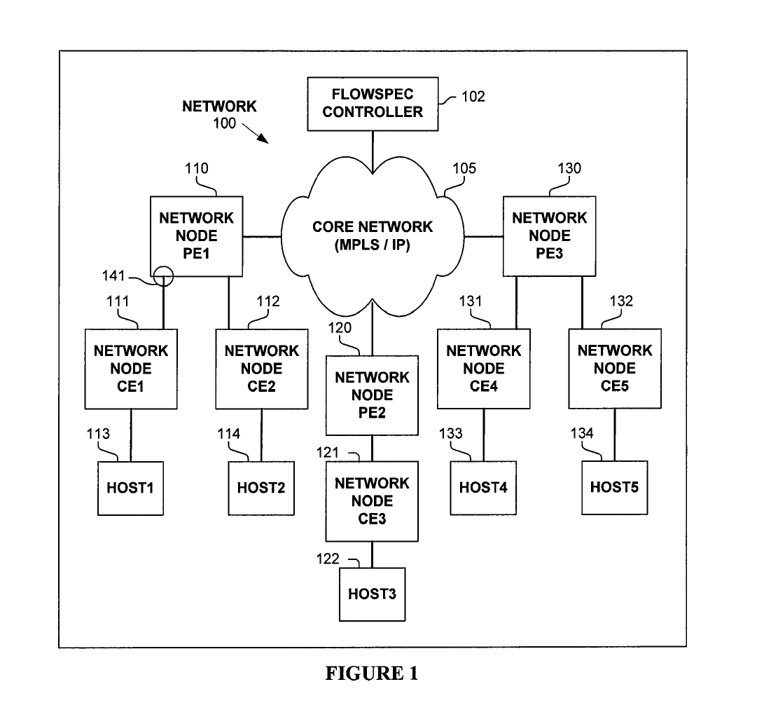

FIG. 1 illustrates a network 100 operating according to one embodiment. Shown are core network 105; provider edge nodes (e.g., packet switching devices/routers) 110, 120, and 130; customer edge nodes (e.g., packet switching devices/routers) 111, 112, 121, 131, and 132; and customer hosts (e.g., end-devices, packet switching devices/routers with hosts behind them) 113, 114, 122, 133, and 134.

In one embodiment, Flowspec controller 102 disseminates throughout network 100, or at least the provider portion 105, 110, 120, 130, Border Gateway Protocol (BGP) Flowspec rules to throttle traffic, such as, but not limited to, in response to identified threats and/or attacks to the network.

In one embodiment and in response to an identified threat coming from host1 (113), Flowspec controller disseminates a Flowspec rule using BGP Flowspec messages to node of the provider portion 105, 110, 120, 130 of network 100. The BGP Flowspec rule typically includes a tuple characterizing the flow of packets to be throttled. In a prior approach, each of provider edge nodes 110, 120, and 130 would configure flow throttling engines for each of its customer-facing interfaces.

One embodiment, such as that illustrated in FIG. 1, configures flow throttling engines in each of provider edge nodes 110, 120, and 130 for only customer-facing interfaces that are identified based on network configuration (e.g., routing/forwarding tables) that are correct in receiving packets of the flow of packet traffic at issue. Flows of packet traffic enter the provider network via one or more of provider edge nodes 110, 120, and 130. In one embodiment, a particular flow of traffic to be throttled as identified in BGP Flowspec messages received by each provider edge nodes 110, 120, and 130. Each of provider edge nodes 110, 120, and 130 performs an analysis to determine on which of its interfaces packets of the particular flow can be properly received. In one embodiment, the particular flow of traffic specified in the BGP Flowspec messages enters the provider edge network only from customer edge node CE1 (111). Provider edge node PE1 110 only configures a flow throttling engine associated with ingress interface 141, and not throttling engines associated with other interfaces (e.g., that receive packet traffic from customer edge network node CE2 112 nor from core network 105). Provider edge nodes PE2 120 and PE3 130 do not configure throttling engines associated with their interfaces as they will not properly receive the flow of traffic identified in the BGP Flowspec messages.

In one embodiment, the analysis of network nodes 110, 120, and 130 performed in response to a received BGP Flowspec message includes performing a unicast reverse path forwarding (uRPF) check operation (typically a strict uRPF check) on a source address prefix associated with the received Flowspec rule. As used herein, the term “prefix” refers to a partial address (e.g., 10.0.*.*) or fully-expanded address (10.0.0.1). The strict uRPF operation verifies that the source address prefix is in a routing/forwarding table associated with an ingress interface. Typically, the routing/forwarding tables are derived from routing information exchanged among packet switching devices in the network using one or more routing protocols.

One embodiment of a provider edge node performs a strict uRPF operation using the received source address prefix for each of its customer-facing interfaces. Based on this analysis, the provider edge node only programs flow throttling engine(s) associated with ingress interfaces identified as verified by a strict uRPF operation.

In one embodiment, network customer edge nodes 111, 112, 121, 131, and 132 program throttling engines in a same manner on only those interfaces identified as properly receiving a specified flow of packet traffic.

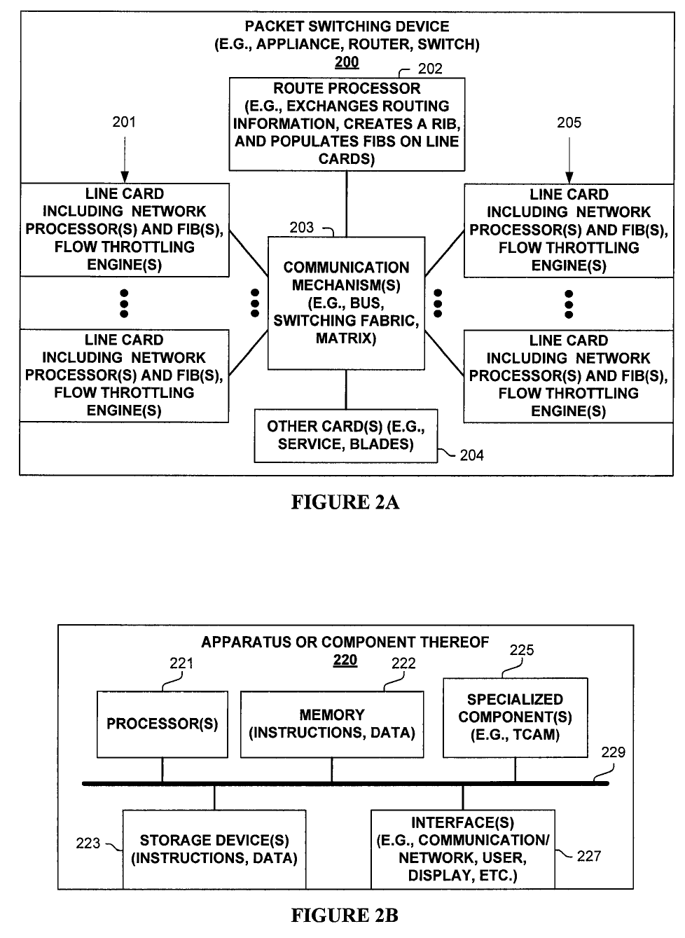

One embodiment of a packet switching device 200 is illustrated in FIG. 2A. As shown, packet switching device 200 includes multiple line cards 201 and 205, each with one or more network interfaces for sending and receiving packets over communications links (e.g., possibly part of a link aggregation group), and with one or more processors that are used in one embodiment associated with selective configuring of throttling engines for flows of packet traffic. Packet switching device 200 also has a control plane with one or more processors 202 for managing the control plane and/or control plane processing of packets associated with selective configuring of throttling engines for flows of packet traffic. Packet switching device 200 also includes other cards 204 (e.g., service cards, blades) which include processors that are used in one embodiment to process packets with selective configuring of throttling engines for flows of packet traffic, and some communication mechanism 203 (e.g., bus, switching fabric, matrix) for allowing its different entities 201, 202, 204 and 205 to communicate.

Line cards 201 and 205 typically perform the actions of being both an ingress and egress line card, in regards to multiple other particular packets and/or packet streams being received by, or sent from, packet switching device 200. In one embodiment, line cards 201 and/or 205 use command message generation and execution using a machine code-instruction to perform prefix or other address matching on forwarding information bases (FIBs) to determine how to ingress and/or egress process packets. Even though the term FIB includes the word “forwarding,” this information base typically includes other information describing how to process corresponding packets.

In one embodiment, the analysis of which interfaces can receive an identified flow of packet traffic is performed by each individual line card 201, 205, possibly singularly or for multiple network processor units, etc. In one embodiment, the analysis of which interfaces can receive an identified flow of packet traffic is performed by route processor 202.

FIG. 2B is a block diagram of an apparatus 220 used in one embodiment associated with selective configuring of throttling engines for flows of packet traffic. In one embodiment, apparatus 220 performs one or more processes, or portions thereof, corresponding to one of the flow diagrams illustrated or otherwise described herein, and/or illustrated in another diagram or otherwise described herein. In one embodiment, these processes are performed in one or more threads on one or more processors.

In one embodiment, apparatus 220 includes one or more processor(s) 221 (typically with on-chip memory), memory 222, storage device(s) 223, specialized component(s) 225 (e.g., ternary content-addressable memory(ies) such as for performing flow identification packet processing operations, etc.), and interface(s) 227 for communicating information (e.g., sending and receiving packets, user-interfaces, displaying information, etc.), which are typically communicatively coupled via one or more communications mechanisms 229 (e.g., bus, links, switching fabric, matrix), with the communications paths typically tailored to meet the needs of a particular application.

Various embodiments of apparatus 220 may include more or fewer elements. The operation of apparatus 220 is typically controlled by processor(s) 221 using memory 222 and storage device(s) 223 to perform one or more tasks or processes. Memory 222 is one type of computer-readable/computer-storage medium, and typically comprises random access memory (RAM), read only memory (ROM), flash memory, integrated circuits, and/or other memory components. Memory 222 typically stores computer-executable instructions to be executed by processor(s) 221 and/or data which is manipulated by processor(s) 221 for implementing functionality in accordance with an embodiment. Storage device(s) 223 are another type of computer-readable medium, and typically comprise solid state storage media, disk drives, diskettes, networked services, tape drives, and other storage devices. Storage device(s) 223 typically store computer-executable instructions to be executed by processor(s) 221 and/or data which is manipulated by processor(s) 221 for implementing functionality in accordance with an embodiment.

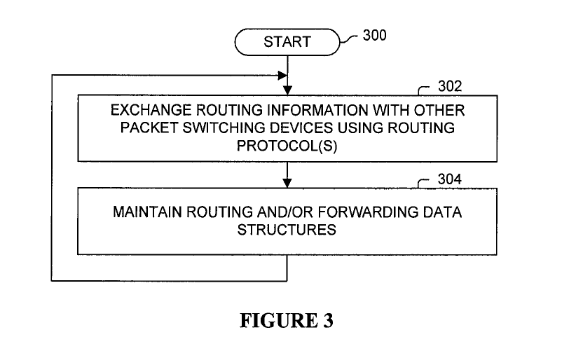

FIG. 3 illustrates a process performed by one embodiment in building the routing/forwarding tables in a packet switching device. Processing begins with process block 300. In process block 302, routing information is exchanged among packet switching devices in the network using one or more routing protocols. In process block 304, the routing/forwarding data structures are maintained according to the exchanged routing information. Processing returns to process block 302.

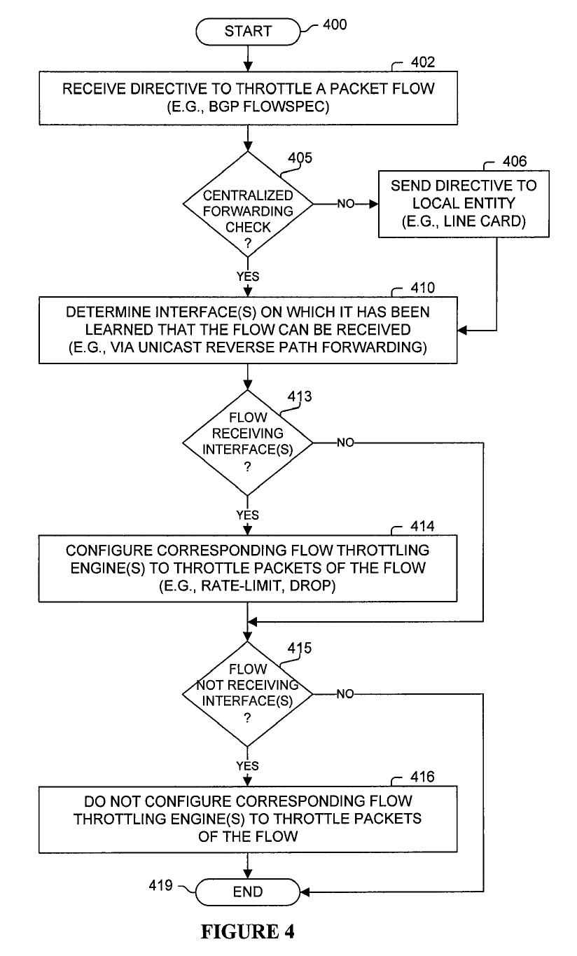

FIG. 4 illustrates a process performed in one embodiment. Processing begins with process block 400. In process block 402, a packet switching device receives a directive to throttle a flow of packet traffic. In one embodiment, this directive is a rule in a received BGP Flowspec message. As determined in process block 405, if the packet switching device performs a centralized forwarding check (e.g., on the route processor instead of on individual line cards) to determine on which interfaces the flow of packet traffic is expected (e.g., based on learned information in a routing/forwarding data structure), then process proceeds directly to process block 410. Otherwise, in process block 406, the directive is communicated to each of the local entities (e.g., line cards, network processor complexes) according to the architecture of the packet switching device, and processing proceeds to process block 410.

In process block 410, the route processor and/or one or more local entities perform an analysis based on which interface(s) it has been learned that packet of the flow of packets can be expected and which interface(s) it has not been learned that packet of the flow of packets can be expected.

In process blocks 413 and 414, the flow throttling engine(s) associated with an interface that has been learned to expect packets of the flow of packets are configured to throttle (e.g., rate-limit, dropped—directly or marked for dropping) packets of the flow of packet traffic. In one embodiment, one or more entries are programmed in a ternary content-addressable memory (TCAM) for identifying packets of the flow of packet traffic by the flow throttling engine. In one embodiment, only a single flow throttling engine is configured to throttle the flow of traffic per the analysis of process block 410 and 413.

In process blocks 415 and 416, the flow throttling engine(s) that are not associated with an interface that has been learned that packets of the flow of packets are not to be expected are not configured to throttle packets of the flow of packet traffic. In one embodiment, all flow throttling engines, except a single flow throttling engine, are not configured to throttle the flow of traffic per the analysis of process block 410 and 415.

Processing of the flow diagram of FIG. 4 is complete as indicated by process block 419.

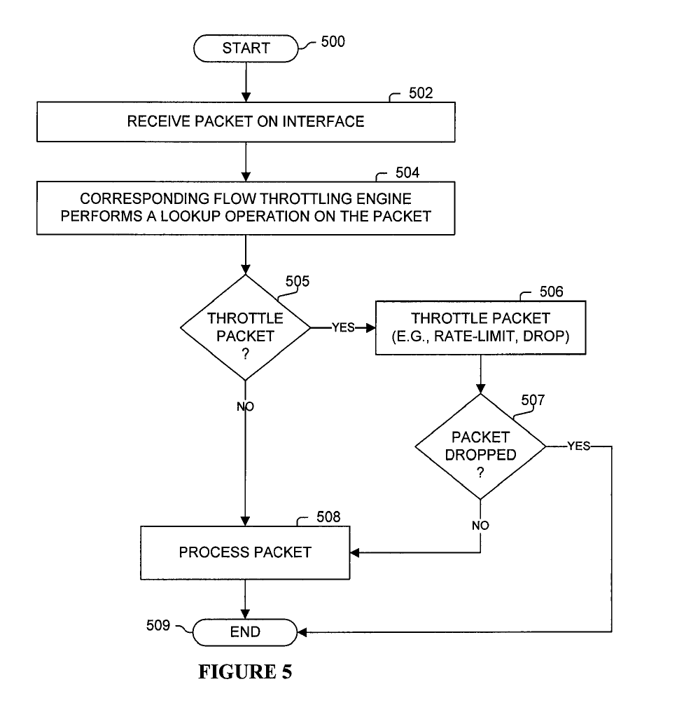

FIG. 5 illustrates a process performed in one embodiment. Processing begins with process block 500. In process block 502, a packet is received on an interface of a packet switching device. In process block 504, a flow throttling engine associated with the receiving ingress interface performs a lookup operation (e.g., using a programmed TCAM, on a data structure) based on one or more characteristics (e.g., source address/source address prefix) of the packet. As determined in process block 505, if the lookup operation of process block 504 identifies to throttle the packet, then in process block 506, the packet is throttled, such as by, but not limited to, rate-limiting or dropping of the packet. As determined in process block 507, if this throttling drops the packet, then processing of the flow diagram of FIG. 5 is complete as indicated by process block 509. Otherwise, processing proceeds to process block 508 wherein the packet is processed by the packet switching device. Processing of the flow diagram of FIG. 5 is complete as indicated by process block 509.

In view of the many possible embodiments to which the principles of the disclosure may be applied, it will be appreciated that the embodiments and aspects thereof described herein with respect to the drawings/figures are only illustrative and should not be taken as limiting the scope of the disclosure. For example, and as would be apparent to one skilled in the art, many of the process block operations can be re-ordered to be performed before, after, or substantially concurrent with other operations. Also, many different forms of data structures could be used in various embodiments. The disclosure as described herein contemplates all such embodiments as may come within the scope of the following claims and equivalents thereof.

What is claimed is:

1. A method, comprising:
receiving, by a packet switching device, a particular directive to throttle a flow of packet traffic;
performing an analysis, by the packet switching device, to determine one or more reduced number of flow throttling engines of a plurality of flow throttling engines in the packet switching device configured to be responsive to a received directive to throttle a corresponding flow of packet traffic, with said one or more reduced number of flow throttling engines corresponding to learned one or more incoming interfaces on which packets of the flow of packet traffic are correct in being received, wherein said one or more reduced number of flow throttling engines is less than all of the plurality of flow throttling engines; and
configuring, by the packet switching device, to throttle the flow of packet traffic in each of said one or more reduced number of flow throttling engines; wherein at least one of the plurality of flow throttling engines associated with an interface identified as not correct in having packets of the flow of packet traffic being received is not configured to throttle the flow of packet traffic.

2. The method of claim 1, wherein the particular directive identifies the flow by a tuple including a source address prefix, partial or fully-expanded, for packets of the flow of packet traffic; and wherein said performing the analysis includes performing a unicast reverse path forwarding (uRPF) check on the source address prefix in identifying said one or more incoming interfaces.

3. The method of claim 2, wherein the uRPF check is performed in strict mode.

4. The method of claim 3, wherein said performing the analysis includes determining not to configure a second flow throttling engine of the plurality of flow throttling engines not in said one or more reduced number of flow throttling engines in response to a strict-mode unicast reverse path forwarding check identifying that a second interface is not on a learned path for the source address prefix, wherein the second flow throttling engine is associated with throttling packet traffic received on the second interface.

5. The method of claim 3, comprising:
receiving, by the packet switching device, a plurality of route advertisements sent by other packet switching devices using one or more routing protocols; and
building, by the packet switching device, one or more forwarding or routing tables based on routing information received in the plurality of route advertisements;
wherein said uRPF check is performed using at least one of said one or more forwarding or routing tables.

6. The method of claim 5, wherein the particular directive is received via one or more Border Gateway Protocol (BGP) messages; and wherein the particular directive includes a BGP Flowspec rule identifying the source address prefix.

7. The method of claim 6, wherein all of the plurality of flow throttling engines not in said one or more reduced number of flow throttling engines are not configured to throttle the flow of packet traffic.

8. The method of claim 1, wherein said throttling the flow of packet traffic results in dropping packets of the flow of packet traffic.

9. The method of claim 1, wherein said throttling the flow of packet traffic includes rate-limiting the flow of packet traffic.

10. The method of claim 1, wherein said configuring each of said one or more reduced number of flow throttling engines includes programming a ternary content-addressable memory in each of said one or more reduced number of flow throttling engines to match packets of the flow of packet traffic.

11. The method of claim 1, wherein the particular directive is received via one or more Border Gateway Protocol (BGP) messages; and wherein the particular directive includes a BGP Flowspec rule identifying the source address prefix.

12. The method of claim 11, wherein the particular directive identifies the flow of packet traffic by a tuple including a source address prefix, partial or fully-expanded, for packets of the flow of packet traffic; and wherein said performing the analysis includes performing a strict-mode unicast reverse path forwarding (uRPF) check on the source address prefix in identifying said one or more learned incoming interfaces on which packets of the flow of packet traffic are correct in being received.

13. A method, comprising:
receiving, by a packet switching device, a particular directive to throttle a flow of packet traffic with packets of the flow of packet traffic associated with a source address prefix, partial or fully-expanded; and
configuring, by the packet switching device, the source address prefix for throttling packet traffic of the flow of packet traffic in a first flow throttling engine in the packet switching device in response to a strict-mode unicast reverse path forwarding check that a first interface is on a learned path for the source address prefix, wherein the first flow throttling engine is associated with throttling traffic received on the first interface.

14. The method of claim 13, wherein the particular directive is received in one or more Border Gateway Protocol (BGP) messages; and wherein the particular directive includes a BGP Flowspec rule identifying the source address prefix.

15. The method of claim 13, comprising determining, by the packet switching device, not to configure a second flow throttling engine in the packet switching device in response to a strict-mode unicast reverse path forwarding check identifying that a second interface is not on a learned path for a source address prefix, wherein the second flow throttling engine is associated with throttling traffic received on the second interface.

16. The method of claim 13, comprising determining, by the packet switching device, not to configure the first flow throttling engine in the packet switching device to throttle a second flow of packet traffic in response to a strict-mode unicast reverse path forwarding check that the first interface is not on a learned path for a second source address prefix, partial or fully-expanded, associated with the second flow of packet traffic.

17. A packet switching device, comprising:
one or more processors;
memory;
a plurality of interfaces configured to send and receive packets, including a particular interface;
a flow throttling engine associated with throttling packet traffic received on the particular interface; and
one or more packet switching mechanisms configured to packet switch packets among said interfaces;
wherein said one or more processors are configured to perform operations, including configuring a source address prefix, partial or fully-expanded, for throttling packet traffic of a flow of packet traffic in the flow throttling engine in response to a strict-mode unicast reverse path forwarding check identifying that the particular interface is on a learned path for the source address prefix; and
wherein packets of the flow of packet traffic are associated with the source address prefix.

18. The packet switching device of claim 17, wherein said operations include determining not to configure the source address prefix for throttling packet traffic of the flow of packet traffic in the flow throttling engine in response to a strict-mode unicast reverse path forwarding check identifying that the particular interface is not on a learned path for the source address prefix.

19. The packet switching device of claim 18, wherein said operation of configuring the source address prefix for throttling packet traffic of the flow of packet traffic in the flow throttling engine is configured to be performed in response to a received Border Gateway Protocol (BGP) Flowspec rule identifying the source address prefix.

20. The packet switching device of claim 17, wherein said operation of configuring the source address prefix for throttling packet traffic of the flow of packet traffic in the flow throttling engine is configured to be performed in response to a received Flowspec rule identifying the source address prefix.
